(19) United States
(12) Patent Application Publication
(10) Pub. No.: US 2024/0204257 A1
(43) Pub. Date: Jun. 20, 2024

(54) LITHIUM-ION SECONDARY BATTERY

(71) Applicant: Prime Planet Energy & Solutions, Inc., Tokyo (JP)

(72) Inventor: Yuta YANO, Seto-shi (JP)

(21) Appl. No.: 18/489,847

(22) Filed: Oct. 19, 2023

(30) Foreign Application Priority Data
Dec. 7, 2022 (JP) 2022-195681

(51) Int. Cl. H01M 10/0569

(52) U.S. Cl. CPC H01M 10/0569; H01M 10/0525

(57) ABSTRACT

A lithium-ion secondary battery includes a positive electrode plate, a negative electrode plate, and an electrolytic solution including LiPF₆, and the electrolytic solution contains a boric acid triester compound for capturing fluoride ions.

### CROSS-REFERENCE TO RELATED APPLICATIONS

This application is based upon and claims the benefit of priority from the prior Japanese Patent Application No. 2022-195681 filed on Dec. 7, 2022, the entire contents of which are incorporated herein by reference.

### BACKGROUND

### Technical Field

The present disclosure relates to a lithium-ion secondary battery.

### Related Art

Japanese unexamined patent application publication No. 2021-22525 discloses a lithium-ion secondary battery that includes a nonaqueous electrolytic solution containing a sultone compound A and a boron compound B. In the lithium-ion secondary battery, increase of resistance during storage of the battery can be inhibited by the effect of the sultone compound A. Although the reason is not clear, it is considered that a coating derived from the sultone compound A is formed on a surface of an electrode (negative electrode or positive electrode) while the battery is stored, and degradation of the electrode is prevented by the effect of the coating formed during storage of the battery, thereby inhibiting increase of resistance.

Furthermore, in the lithium-ion secondary battery, initial resistance (that is, resistance before storage) of the battery can be reduced by the effect of the boron compound B. Although the reason is not clear, it is considered that the boron compound B has higher reduction reactivity than the sultone compound A, and this may be associated with reduction of initial resistance. That is, it is considered that, since the boron compound B has high reduction reactivity, a coating is formed on the surface of the negative electrode by the boron compound B more quickly than the sultone compound A before the battery is stored. The initial resistance (resistance before storage) of the battery is considered to be reduced by the effect of the coating formed before storage of the battery.

### SUMMARY

### Technical Problems

To date, in an electrolytic solution containing LiPF₆, for example, HF (hydrogen fluoride) has been likely to be generated by reaction between LiPF₆ and a small amount of water contained in the electrolytic solution. By the action of fluoride ions (F) generated by ionization of the HF, corrosion of current collecting foil constituting a positive electrode plate or a negative electrode plate, decomposition of a positive active material, and decomposition of a coating of a negative active material may be caused.

The present disclosure has been made in view of such circumstances, and an object of the present disclosure is to provide a lithium-ion secondary battery capable of inhibiting “corrosion of current collecting foil, decomposition of a positive active material, and decomposition of a coating of a negative active material”.

### Means of Solving the Problems

(1) One aspect of the present disclosure is a lithium-ion secondary battery comprising; a positive electrode plate; a negative electrode plate; and an electrolytic solution containing LiPF₆, wherein the electrolytic solution contains a boric acid triester compound for capturing fluoride ions.

In the above-described lithium-ion secondary battery, the electrolytic solution containing a “boric acid triester compound for capturing fluoride ions (F⁻)” is used as the electrolytic solution. In such a lithium-ion secondary battery, fluoride ions generated by ionization of HF can be captured by the boric acid triester compound contained in the electrolytic solution, and thus, “corrosion of current collecting foil, decomposition of a positive active material, and decomposition of a coating of a negative active material” can be inhibited. Fluoride ions are captured by the boric acid triester compound through coordinate bond to boron atoms in the boric acid triester compound.

Examples of the boric acid triester compound include trialkyl borate, triphenyl borate, tri(alkylated phenyl)borate, and tri(halogenated phenyl)borate. Among them, examples of the trialkyl borate include triethyl borate, tris(hexafluoroisopropyl)borate, and trioctadecyl borate. Examples of the tri(alkylated phenyl)borate include tri-o-tolyl borate and tri(2,4,6-trimethylphenyl)borate. Examples of the tri(halogenated phenyl)borate include tri(4-chlorophenyl)borate and tri(2,4,6-trifluorophenyl)borate.

(2) Further preferably, in the lithium-ion secondary battery according to the above (1), the boric acid triester compound is tri(halogenated phenyl)borate.

Tri(halogenated phenyl)borate is a compound having a particularly high ability to capture fluoride ions among the boric acid triester compounds. Therefore, in the above-described lithium-ion secondary battery, fluoride ions generated by ionization of HF can be efficiently captured by the tri(halogenated phenyl)borate. Accordingly, in the above-described lithium-ion secondary battery, “corrosion of current collecting foil, decomposition of a positive active material, and decomposition of a coating of a negative active material” can be sufficiently inhibited. As the tri(halogenated phenyl)borate, for example, tri(4-chlorophenyl)borate, tri(2,4,6-trifluorophenyl)borate, or the like may be used.

(3) Further preferably, in the lithium-ion secondary battery according to the above (2), the tri(halogenated phenyl)borate is contained in the electrolytic solution at a concentration of 1.0 mol/L or more and 2.0 mol/L or less.

In the above-described lithium-ion secondary battery, a concentration of the tri(halogenated phenyl)borate in the electrolytic solution is 1.0 mol/L or more and 2.0 mol/L or less. In a case where a proportion of the tri(halogenated phenyl)borate contained in the electrolytic solution is 1.0 mol/L or more, an effect of capturing fluoride ions generated by ionization of HF can be enhanced. However, even if the concentration of the tri(halogenated phenyl)borate is greater than 2.0 mol/L, the effect of capturing fluoride ions is unchanged. Therefore, even if the concentration of the tri(halogenated phenyl)borate is made greater than 2.0 mol/L, the tri(halogenated phenyl)borate is added more than necessary, and thus the tri(halogenated phenyl)borate is wasted. Therefore, the electrolytic solution preferably contains the tri(halogenated phenyl)borate at a proportion ranging from 1.0 to 2.0 mol/L.

### BRIEF DESCRIPTION OF THE DRAWINGS

FIG. 1 is a perspective view of a lithium-ion secondary battery in an embodiment;

FIG. 2 is a plan view of a positive electrode plate of the lithium-ion secondary battery; and

FIG. 3 is a plan view of a negative electrode plate of the lithium-ion secondary battery.

### DETAILED DESCRIPTION OF THE EXEMPLARY EMBODIMENTS

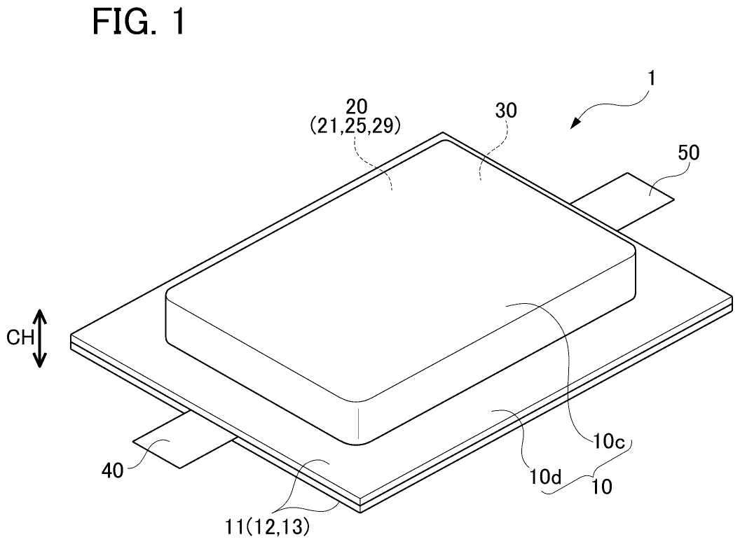

Next, a lithium-ion secondary battery 1 according to an embodiment will be described with reference to the accompanying drawings. The lithium-ion secondary battery 1 includes a casing 10 formed of laminate films 11, an electrode body 20 and an electrolytic solution 30 stored inside the casing 10, and a positive terminal 40 and a negative terminal 50 that extend externally from the casing 10 (see FIG. 1). A large part of the electrolytic solution 30 is impregnated into the electrode body 20.

The casing 10 is formed by overlapping a pair of rectangular laminate films 11 one on the other, and heat-welding peripheral edge portions of the laminate films 11. Therefore, the casing 10 includes a storage portion 10c for storing therein the electrode body 20 and the electrolytic solution 30, and a sealing portion 10d which has a rectangular-ring shape in a planar view, which is disposed at the peripheral edge of the storage portion 10c, and which air-tightly seals the storage portion 10c (see FIG. 1). The laminate film 11 forming the casing 10 is a laminate film having a three-layer structure which is composed of a metal foil 12, and a pair of resin films 13 stacked on both surfaces of the metal foil 12.

The electrode body 20 includes a rectangular positive electrode plate 21, a rectangular negative electrode plate 25, and a rectangular separator 29 disposed between the positive electrode plate 21 and the negative electrode plate 25. The electrode body 20 has a structure in which the positive electrode plate 21, the negative electrode plate 25, and the separator 29 are stacked in a thickness direction CH.

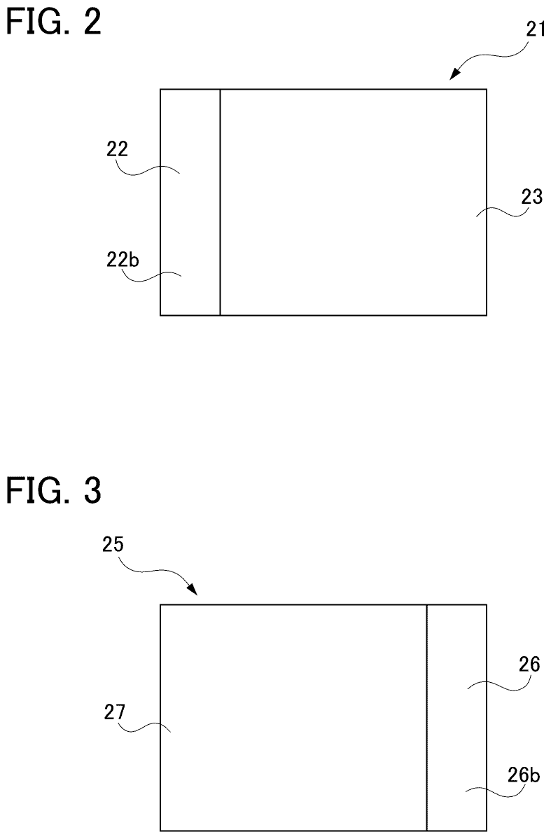

The positive electrode plate 21 includes a positive current collecting foil 22 formed of aluminum foil, and a positive active material layer 23 stacked on the surface of the positive current collecting foil 22 (see FIG. 2). The positive active material layer 23 includes positive active material particles and a binding agent. In the present embodiment, as the positive active material particles, lithium transition metal composite oxide particles, specifically, lithium nickel cobalt manganese composite oxide particles are used. As the binding agent, polyvinylidene fluoride (PVDF) is used. At one end portion (i.e., a left end portion in FIG. 2) of the positive electrode plate 21, the positive active material layer 23 is not disposed on the surface of the positive current collecting foil 22, and a positive current collecting portion 22b, at which the positive current collecting foil 22 is exposed, is formed. The positive terminal 40 described below is electrically connected to the positive current collecting portion 22b.

The negative electrode plate 25 includes a negative current collecting foil 26 formed of a copper foil, and a negative active material layer 27 stacked on the surface of the negative current collecting foil 26 (see FIG. 3). The negative active material layer 27 includes negative active material particles and a binding agent. In the present embodiment, as the negative active material particles, graphite particles are used. At the other end portion (i.e., a right end portion in FIG. 3) of the negative electrode plate 25, the negative active material layer 27 is not disposed on the surface of the negative current collecting foil 26, and a negative current collecting portion 26b, at which the negative current collecting foil 26 is exposed, is formed. The negative terminal 50 described below is electrically connected to the negative current collecting portion 26b.

The positive terminal 40 is made of aluminum and formed in an elongated shape. One end portion of the positive terminal 40 is connected to the positive current collecting portion 22b of the positive electrode plate 21 constituting the electrode body 20, and is disposed in the storage portion 10c of the casing 10 (see FIGS. 1 and 2). The positive terminal 40 extends externally from the casing 10 through the sealing portion 10d of the casing 10.

The negative terminal 50 is made of copper and formed in an elongated shape. One end portion of the negative terminal 50 is connected to the negative current collecting portion 26b of the negative electrode plate 25 constituting the electrode body 20, and is stored in the storage portion 10c of the casing 10 (see FIGS. 1 and 3). The negative terminal 50 extends externally from the casing 10 through the sealing portion 10d of the casing 10. The negative terminal 50 extends in the direction opposite to the extending direction of the positive terminal 40.

The electrolytic solution 30 is a nonaqueous electrolytic solution including an organic solvent and LiPF₆. In the present embodiment, the organic solvent that is obtained by mixing ethylene carbonate, ethyl methyl carbonate, and dimethyl carbonate at a weight ratio of 3:3:4 is used. The concentration of LiPF₆ in the electrolytic solution 30 is 1.16 mol/L.

To date, in an electrolytic solution containing LiPF₆, HF (hydrogen fluoride) has been likely to be generated by the reaction between LiPF₆ and a small amount of water contained in the electrolytic solution. By the action of fluoride ions (F⁻) generated by ionization of the HF, corrosion of current collecting foil constituting a positive electrode plate or a negative electrode plate, decomposition of a positive active material, and decomposition of a coating of a negative active material may be caused.

Meanwhile, the electrolytic solution 30 of the present embodiment contains a boric acid triester compound for capturing fluoride ions (F⁻). Therefore, in the lithium-ion secondary battery 1 of the present embodiment, fluoride ions generated by ionization of HF can be captured by the boric acid triester compound contained in the electrolytic solution 30. Thus, “corrosion of the current collecting foil, decomposition of the positive active material, and decomposition of the coating of the negative active material” can be inhibited. Fluoride ions are captured by the boric acid triester compound through coordinate bond to boron atoms in the boric acid triester compound.

As the boric acid triester compound, for example, trialkyl borate, triphenyl borate, tri(alkylated phenyl)borate, and tri(halogenated phenyl)borate can be used. Among them, as the trialkyl borate, for example, triethyl borate, tris(hexafluoroisopropyl)borate, and trioctadecyl borate can be used. As the tri(alkylated phenyl)borate, for example, tri-o-tolyl borate and tri(2,4,6-trimethylphenyl)borate can be used. As the tri(halogenated phenyl)borate, for example, tri(4-chlorophenyl)borate and tri(2,4,6-trifluorophenyl)borate can be used.

The tri(halogenated phenyl)borate is a compound having a particularly high ability to capture fluoride ions among the boric acid triester compounds. Therefore, in a case where the electrolytic solution 30 containing the tri(halogenated phenyl)borate is used as the electrolytic solution 30, fluoride ions generated by ionization of HF can be efficiently captured by the tri(halogenated phenyl)borate. Thus, “corrosion of the current collecting foil, decomposition of the positive active material, and decomposition of the coating of the negative active material” can be sufficiently inhibited. As the tri(halogenated phenyl)borate, tri(4-chlorophenyl)borate, tri(2,4,6-trifluorophenyl)borate, or the like may be used.

### Example 1

In the lithium-ion secondary battery 1 of Example 1, the electrolytic solution 30 containing trialkyl borate as the boric acid triester compound is used. More specifically, triethyl borate represented by the following chemical formula 1 is used as the trialkyl borate. The concentration of the triethyl borate in the electrolytic solution 30 is 1.0 mol/L.

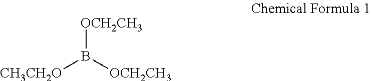

### Example 2

In the lithium-ion secondary battery 1 of Example 2, the electrolytic solution 30 containing triphenyl borate as the boric acid triester compound is used. The triphenyl borate is a compound represented by the following chemical formula 2. The concentration of the triphenyl borate in the electrolytic solution 30 is 1.0 mol/L.

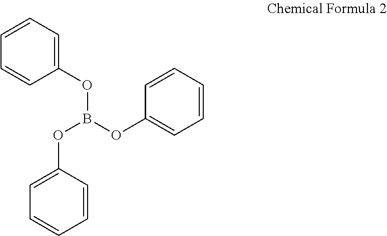 [SMILES: c1ccc(OB(Oc2ccccc2)Oc2ccccc2)cc1]

### Example 3

In the lithium-ion secondary battery 1 of Example 3, the electrolytic solution 30 containing tri(alkylated phenyl)borate as the boric acid triester compound is used. More specifically, as the tri(alkylated phenyl)borate, tri-o-tolyl borate represented by the following chemical formula 3 is used. The concentration of the tri-o-tolyl borate in the electrolytic solution 30 is 1.0 mol/L.

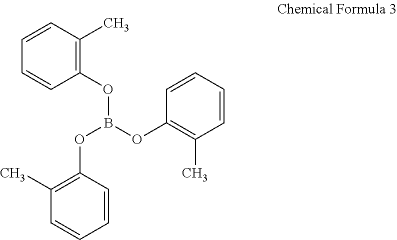 [SMILES: Cc1ccccc1OB(Oc1ccccc1C)Oc1ccccc1C]

### Examples 4 to 7

In the lithium-ion secondary battery 1 of each of Examples 4 to 7, the electrolytic solution 30 containing tri(halogenated phenyl)borate as the boric acid triester compound is used. More specifically, as the tri(halogenated phenyl)borate, tri(4-chlorophenyl)borate represented by the following chemical formula 4 is used.

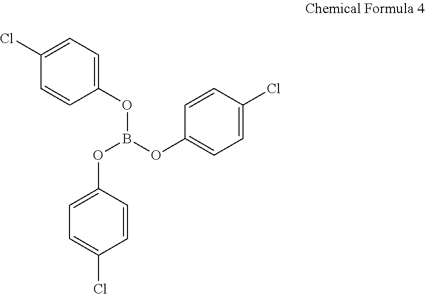 [SMILES: Clc1ccc(OB(Oc2ccc(Cl)cc2)Oc2ccc(Cl)cc2)cc1]

In Examples 4 to 7, the concentrations of the tri(4-chlorophenyl)borate in the electrolytic solution 30 are different from one another. Specifically, in the Example 4, the concentration of the tri(4-chlorophenyl)borate in the electrolytic solution 30 is 1.0 mol/L. In the Example 5, the concentration of the tri(4-chlorophenyl)borate in the electrolytic solution 30 is 0.1 mol/L. In the Example 6, the concentration of the tri(4-chlorophenyl)borate in the electrolytic solution 30 is 2.0 mol/L. In the Example 7, the concentration of the tri(4-chlorophenyl)borate in the electrolytic solution 30 is 5.0 mol/L.

### Comparative Example 1

A lithium-ion secondary battery of Comparative example 1 is similar to the lithium-ion secondary battery 1 of each of the Examples 1 to 7 except that no boric acid triester compound is contained in the electrolytic solution.

### <Test for Evaluating Ability to Capture Fluoride Ions>

For the lithium-ion secondary battery of each of the Examples 1 to 7 and the Comparative example 1, the ability to capture fluoride ions is evaluated. Firstly, for each lithium-ion secondary battery, the following cycle charging-discharging is performed. Specifically, constant current charging is performed for each lithium-ion secondary battery in a state where a battery voltage value is 3.0 V, at a constant current of 1 C until the battery voltage value reaches 4.3 V. Subsequently, constant current discharging is performed at a constant current of 0.5 C until the battery voltage value reaches 3.0 V. This charging-discharging cycle is set as one cycle, and five cycles of the charging-discharging is performed for each lithium-ion secondary battery.

Thereafter, each lithium-ion secondary battery is disassembled, and the concentration of fluoride ions contained in the negative electrode plate 25 is measured by IC (ion chromatography) analysis. In this test, the IC analysis is performed as follows.

Firstly, the lithium-ion secondary battery 1 of the Example 1 having been subjected to the above-described cycle charging-discharging is disassembled, and the negative electrode plate 25 is taken out. From the negative electrode plate 25 having been taken out, a square test piece having a dimension of 30 mm in a longitudinal direction and a dimension of 30 mm in a traverse direction was cut out. Subsequently, the test piece having been cut out is immersed in acetonitrile. Ultrasonic vibration is applied to the acetonitrile in which the test piece was immersed, the negative active material layer 27 is peeled off from the negative current collecting foil 26, and fluoride ions contained in the test piece are dissolved in acetonitrile to obtain an acetonitrile solution. Subsequently, the acetonitrile solution is filtered to obtain filtrate containing the fluoride ions. The filtrate is subjected to IC analysis, and the fluoride ion concentration is thus measured.

In this test, as the IC analyzer, an ion chromatography system (ICS-6000) manufactured by Thermo Fisher Scientific (former Nippon Dionex K.K.) is used. The fluoride ion concentration is a mass % concentration with respect to the negative active material contained in the test pieces. Also for the lithium-ion secondary battery of each of the Examples 2 to 7 and the Comparative example 1, the fluoride ion concentration (mass %) is measured in the same manner. The results of the measurement are indicated in the Table 1.

TABLE 1

| | | Concentration of | Fluoride ion |
|---|---|---|---|
| | | boric acid | concentration |
| | | triester | (mass %) after |
| | Type of boric acid | compound | cycle charging- |
| | triester compound | (mol/L) | discharging |
| Ex. 1 | Triethyl borate | 1.0 | 0.35 |
| Ex. 2 | Triphenyl borate | 1.0 | 0.30 |
| Ex. 3 | Tri-o-tolyl borate | 1.0 | 0.35 |
| Ex. 4 | Tri(4- | 1.0 | 0.23 |
| | chlorophenyl)borate | | |
| Ex. 5 | Tri(4- | 0.1 | 0.40 |
| | chlorophenyl)borate | | |
| Ex. 6 | Tri(4- | 2.0 | 0.17 |
| | chlorophenyl)borate | | |
| Ex. 7 | Tri(4- | 5.0 | 0.17 |
| | chlorophenyl)borate | | |
| Comp. Ex. 1 | N/A | 0 | 0.42 |

As indicated in Table 1, in the lithium-ion secondary battery of the Comparative example 1, the fluoride ion concentration is 0.42 mass % after the above-described cycle charging-discharging. Meanwhile, in the lithium-ion secondary battery of each of the Examples 1 to 7, the fluoride ion concentration is not greater than 0.40 mass % after the above-described cycle charging-discharging, and the value is lower than that of the Comparative example 1.

This is because the electrolytic solution 30 containing the boric acid triester compound is used as the electrolytic solution in the lithium-ion secondary battery 1 of each of the Examples 1 to 7 unlike the lithium ion secondary battery of the Comparative example 1. It can be considered that, in the lithium-ion secondary battery 1 of each of the Examples 1 to 7, fluoride ions generated by ionization of HF are able to be captured by the boric acid triester compound contained in the electrolytic solution 30. Therefore, it can be considered that “corrosion of the current collecting foil, decomposition of the positive active material, and decomposition of the coating of the negative active material” are able to be more effectively inhibited in the lithium-ion secondary battery 1 of each of the Examples 1 to 7 as compared with the lithium-ion secondary battery of the Comparative example 1.

Furthermore, the test results are examined in detail. Firstly, results for the lithium-ion secondary batteries 1 of the Examples 1 to 4 are compared with one another. The different kinds of the boric acid triester compounds were added to the electrolytic solution 30 in the Examples 1 to 4, respectively. However, the added amounts (concentrations) are each 1.0 mol/L, which is the same among the Examples 1 to 4. Specifically, as the boric acid triester compound, trialkyl borate is used in the Example 1, triphenyl borate is used in the Example 2, tri(alkylated phenyl)borate is used in the Example 3, and tri(halogenated phenyl)borate is used in the Example 4. According to comparison in the fluoride ion concentration after the cycle charging-discharging among the Examples 1 to 4, the fluoride ion concentration is 0.30 mass % or more for each of the Examples 1 to 3 whereas the fluoride ion concentration is 0.23 mass % in the Example 4 and indicated the lowest value among the four examples (see Table 1).

This result indicates that the tri(halogenated phenyl)borate of the Example 4 is more preferably used as the boric acid triester compound. It can be considered that tri(halogenated phenyl)borate is a compound having a particularly high ability to capture fluoride ions among boric acid triester compounds. It can be considered that, by using the electrolytic solution 30 containing tri(halogenated phenyl)borate as an electrolytic solution of a lithium-ion secondary battery, fluoride ions generated by ionization of HF can be efficiently captured by the tri(halogenated phenyl)borate. Thus, it can be considered that “corrosion of the current collecting foil, decomposition of the positive active material, and decomposition of the coating of the negative active material” can be sufficiently inhibited. In the Example 4, tri(4-chlorophenyl)borate is used as the tri(halogenated phenyl)borate, but alternatively, tri(2,4,6-trifluorophenyl)borate or the like may be used.

Next, the test results of the Examples 4 to 7 are compared with one another. The Examples 4 to 7 are common to that tri(halogenated phenyl)borate is used as the boric acid triester compound. However, the concentrations thereof are different from one another. Specifically, the concentration of the tri(halogenated phenyl)borate was 0.1 mol/L in the Example 5, 1.0 mol/L in the Example 4, 2.0 mol/L in the Example 6, and 5.0 mol/L in the Example 7. According to comparison in the fluoride ion concentration after the cycle charging-discharging among the Examples 4 to 7, the fluoride ion concentration was 0.40 mass % in the Example 5 whereas the fluoride ion concentration is 0.23 mass % or less and indicates an extremely low value in each of the Examples 4, 6, and 7 (see Table 1).

This result indicates that, by adding the tri(halogenated phenyl)borate to the electrolytic solution of the lithium-ion secondary battery at a proportion of 1.0 mol/L or more, the effect of capturing fluoride ions generated by ionization of HF can be made high. However, as indicated in the test results of the Examples 6 and 7, even if the concentration of the tri(halogenated phenyl)borate is made greater than 2.0 mol/L, the effect of capturing fluoride ions is unchanged. Therefore, the concentration of the tri (halogenated phenyl)borate being greater than 2.0 mol/L means that an unnecessarily large amount of the tri(halogenated phenyl)borate is added, and the tri(halogenated phenyl)borate is wasted. Therefore, it can be considered that the tri(halogenated phenyl)borate is preferably added to the electrolytic solution at a proportion ranging from 1.0 to 2.0 mol/L. That is, the concentration of the tri(halogenated phenyl)borate in the electrolytic solution of the lithium-ion secondary battery preferably ranges from 1.0 to 2.0 mol/L.

The present disclosure has been described above according to the embodiment. However, the present disclosure is not limited to the above-described embodiment, and it is needless to say that modifications can be made as appropriate without departing from the gist of the present disclosure.

For example, in the Example 1, triethyl borate is used as the trialkyl borate. However, the present disclosure is not limited thereto, and, for example, another trialkyl borate such as tris(hexafluoroisopropyl)borate or trioctadecyl borate may be used. In the Example 3, tri-o-tolyl borate is used as the tri(alkylated phenyl)borate. However, the present disclosure is not limited thereto, and another tri(alkylated phenyl)borate such as tri(2,4,6-trimethylphenyl)borate may be used. In the Examples 4 to 7, tri(4-chlorophenyl)borate is used as the tri(halogenated phenyl)borate. However, the present disclosure is not limited thereto, and another tri(halogenated phenyl)borate such as tri(2,4,6-trifluorophenyl)borate may be used.

### REFERENCE SIGNS LIST

10 Outer case
20 Electrode body
21 Positive electrode plate
25 Negative electrode plate
30 Electrolytic solution
40 Positive terminal
50 Negative terminal
1 Lithium-ion secondary battery

What is claimed is:

1. A lithium-ion secondary battery comprising;
a positive electrode plate;
a negative electrode plate; and
an electrolytic solution containing LiPF₆, wherein
the electrolytic solution contains a boric acid triester compound for capturing fluoride ions.

2. The lithium-ion secondary battery according to claim 1, wherein the boric acid triester compound is tri(halogenated phenyl)borate.

3. The lithium-ion secondary battery according to claim 2, wherein the tri(halogenated phenyl)borate is contained in the electrolytic solution at a concentration of 1.0 mol/L or more and 2.0 mol/L or less.
